(19) United States
(12) Patent Application Publication
(10) Pub. No.: US 2025/0354624 A1
(43) Pub. Date: Nov. 20, 2025

(54) METHOD OF DETERMINING AN ANGULAR POSITION OF A SIGNAL GENERATOR, ANGLE DETECTION SYSTEM AND VALVE

(71) Applicant: BUERKERT WERKE GMBH & CO. KG, Ingelfingen (DE)

(72) Inventors: Sagar AGARWAL, Ingelfingen (DE); Nikolai HLUBEK, Ingelfingen (DE); Marisa SCHIERLE, Ingelfingen (DE); Arnaud DECK, Ingelfingen (DE)

(21) Appl. No.: 19/210,816

(22) Filed: May 16, 2025

(30) Foreign Application Priority Data
May 17, 2024 (DE) 102024113992.7

(51) Int. Cl. F16K 37/00

(52) U.S. Cl. CPC F16K 37/0033

(57) ABSTRACT

An angle detection system which includes a signal generator and at least one at least biaxial Hall sensor which is configured to generate at least two measurement signals in at least two different measuring directions on a basis of a magnetic field that changes due to rotation of the signal generator. The signal generator includes a magnet that is polarized such that a magnetic field strength measured by the Hall sensor changes as the signal generator rotates, and the signal generator being arranged within the detection range of the at least one Hall sensor. Based on the measurement signals generated by the at least one Hall sensor, an angular position of the signal generator is determined in a control unit, in particular on the principle of machine learning. Further indicated are an angle detection system and a valve.

### CROSS REFERENCE TO RELATED APPLICATION

This application claims priority from German Patent Application Serial No. 10 2024 113 992.7, Filed May 17, 2024, the contents of which are incorporated herein by reference.

### TECHNICAL FIELD

The disclosure relates to a method of determining an angular position of a magnetic signal generator mounted for rotation about an axis of rotation, an angle detection system for determining an angular position of a signal generator, and a valve having an angle detection system of this type.

### BACKGROUND

It is known to detect in valves the position of a valve tappet and a valve closing element connected thereto in order to determine an opening state of the valve. For this purpose, displacement measuring systems are usually employed that comprise a plurality of Hall sensors arranged in series and a magnetic signal generator that is fastened to one end of the valve tappet and moves within the detection range of the Hall sensors. Here, however, only axial movements of the valve tappet are detected.

It is an object of the present disclosure to allow rotational movements to be detected.

### SUMMARY

The disclosure provides a method of determining an angular position of a magnetic signal generator mounted for rotation about an axis of rotation, for example of determining an opening state of a valve, in an angle detection system which comprises a signal generator and at least one at least biaxial Hall sensor which is configured to generate at least two measurement signals in at least two different measuring directions on the basis of the magnetic field that changes due to rotation of the signal generator, the signal generator comprising a magnet that is polarized such that a magnetic field strength measured by the Hall sensor changes as the signal generator rotates, and the signal generator being arranged within the detection range of the at least one Hall sensor.

In a first method step, the signal generator rotates about its axis of rotation.

When the signal generator rotates, the at least one Hall sensor generates at least two measurement signals in the form of magnetic field components in the at least two different measuring directions. This means that a measurement signal is generated in each measuring direction. Due to the different orientations of the at least two axes, the rotating magnetic field generates different measuring currents in the Hall sensor in the at least two measuring directions thereof.

Based on the measurement signals generated by the at least one Hall sensor, an angular position of the signal generator is determined in a control unit, for example on the principle of machine learning.

The method according to the disclosure can therefore be used to detect a rotation of a signal generator or an element connected thereto, for example a positioning element of a valve, and to determine an angular position of the signal generator, as a result of which the angular position of the positioning element can be inferred.

The different measurement signals generated by the Hall sensor are for example orthogonal to each other.

Preferably, the at least one Hall sensor is a triaxial sensor that is configured to generate three measurement signals in three different measuring directions on the basis of the magnetic field that changes by rotation of the signal generator.

Alternatively, the at least one Hall sensor is a biaxial sensor that is configured to generate two measurement signals in two different measuring directions on the basis of the magnetic field that changes by rotation of the signal generator.

According to a preferred embodiment, the angle detection system comprises only a single Hall sensor.

For example, the control unit is connected to the at least one Hall sensor in a signal-transmitting manner, wherein the control unit has a position determination software stored therein which is configured to determine an angular position of the signal generator based on the measurement signals generated by the at least one Hall sensor, and wherein the position determination software is configured to associate the measuring directions of the measurement signals generated by the Hall sensors with a respective axis of a coordinate system stored in the position determination software. In this way, it is possible to normalize the measurement signals generated by Hall sensors made by different manufacturers so that the angular position can be determined correctly. In fact, the directions of the measurement signals generated by the Hall sensors are associated with a coordinate system stored in the Hall sensor that is not necessarily in agreement with the coordinate system stored in the position determination software. More precisely, spatial directions in the coordinate system of the Hall sensor may be interchanged as compared to the coordinate system stored in the displacement measuring system, for example the x-direction and the y-direction.

The position detection software identifies the type of Hall sensor used, for example using a trigger, for example an analog trigger, and associates the measurement signals with the axes of the coordinate system stored in the position determination software based on the Hall sensor that has been identified.

In one method step, for example, a set of position intensity data of the at least one Hall sensor is provided for a multitude of specified angular positions of the signal generator. In a further method step, a respective current measurement signal for each measuring direction is generated by the Hall sensor for a current angular position of the signal generator. Then the current angular position of the signal generator is determined from the position intensity data and the current measurement signals. For example, the position intensity data is stored in the position determination software.

By matching the current measurement signals with the position intensity data, the current angular position of the signal generator can be inferred, possibly without a transformation of the current measurement signals or without performing calculations with the current measurement signals. In this way, the angular position can be determined both quickly and accurately. For example, a distinct association of the current measurement signals with a current angular position of the signal generator is possible.

According to one embodiment, the position intensity data is invariable. It is provided once beforehand and only needs to be read out in each case for a current angular position determination, which also speeds up the process.

Each change in the angular position of the signal generator in the detection range of the at least one Hall sensor preferably results in a change in the measurement signal for all measuring directions, in particular wherein the change is uniquely reproduced by the characteristic curves of the at least one Hall sensor for the respective measuring directions.

The characteristic curves may vary as a function of the type and manufacturer of the Hall sensor itself, and as a function of other variables such as, for example, the ambient temperature and the aging state. The magnetic field of the signal generator may also depend on the type, temperature and/or aging state.

These characteristic curves can be determined for the at least one Hall sensor for each measuring direction in advance, wherein the characteristic curves can be determined either by analytical, partly empirical, functions or by the recording of measured curves. The characteristic curves are taken as a basis for the position intensity data.

To provide the position intensity data, the signal generator is rotated through a predetermined angular range, in particular through 360 degrees, for example, and the measurement signals generated and also the associated angular position are recorded. This allows the position intensity data to be generated true to reality as possible.

According to a further embodiment, the position intensity data can be calculated. For this purpose, analytical or empirically determined formulae may be employed. For example, a sufficiently accurate, empirically determined fitting curve for a measured characteristic curve would be conceivable.

A combination of both ways of providing the position intensity data is also possible.

The set of position intensity data preferably comprises an entire family of characteristic curves, each of which is adapted to the individual angle detection system. For individual characteristic curves, not only the rotation of the signal generator can be taken into account here, but different ambient temperatures to be expected as well as aging states of the Hall sensors and the signal generator over the expected service life of the angle detection system may also be included. Of course, further, additional parameters that have an influence on the measurement signals detected by the Hall sensors or on the magnetic field of the signal generator may also be incorporated into the position intensity data. The additional parameters contained in the position intensity data comprise, for example, temperature data and/or aging data.

In this context, the position intensity data should correspond as closely as possible to the actual characteristic curves of the at least one Hall sensor, taking into account the appropriate parameters.

For position determination, the respective suitable position intensity data, which is based on the respective characteristic curves, is selected from the set of position intensity data for example as a function of the existing external conditions, such as, for example, the ambient temperature or the operating time of the angle detection system, and the position determination is based on this position intensity data.

The selection of the characteristic curves and parameters to be used from the set of position intensity data as well as the position determination based on the position intensity data itself is performed by a suitable control routine, which is usually integrated in the angle detection system itself and stored as software in the control unit, for example.

The software used may comprise any suitable forms of artificial intelligence or machine learning programs.

The set of position intensity data may be created outside the angle detection system and transferred to the control unit of the angle detection system and stored there. This has the advantage that a set of position intensity data suitable for a multitude of angle detection systems of the same type only needs to be prepared once. This applies, for example, to angle detection systems with Hall sensors and signal generators from the same batch from a manufacturer.

Here, the set of position intensity data may, for example, be based on an exact measurement of the angle detection system and the characteristic curves. This may be performed by rotating the signal generator and measuring the characteristic curves of the at least one Hall sensor for different ambient conditions, for example, wherein the angular positions which are then known are recorded and assigned to the characteristic curves as position data. For example, this can be carried out as part of a teaching process for the angle detection system.

Another option is to create the set of position intensity data in a suitable manner within the angle detection system itself as well. A combination is also possible, wherein the major part of the set of position intensity data is created externally and transferred to the respective angle detection system and the acquisition of additional parameters for the respective individual angle detection system is effected within the angle detection system itself. This can be done, for example, as part of a teaching process.

A current angular position of the signal generator may be performed using machine learning or deep learning, for example in accordance with a nearest neighbor classification or a random forest classification. Alternatively, a nearest neighbor regression or a random forest regression can also be applied. Of course, any other suitable method of shallow learning or of deep learning (e.g. by means of neural networks) is also possible, which lead to an exact current angular position of the signal generator using a set of position intensity data. Trainable models may also be employed. It is also conceivable to retrain the models after a certain period of time.

Methods of artificial intelligence are also applicable to identify and suppress or remedy any inconsistencies and anomalies in the database of the position intensity data.

Preferably, the amount of position intensity data obtained is reduced by a downsampling method and the accuracy of the predicted position is improved by a weighting, for example by an averaging over the predicted most probable positions weighted with their probabilities. More precisely, the downsampling reduces the measurement resolution, which however can be compensated for by a weighting in the nearest neighbors regression or also in the other suitable methods of shallow learning or deep learning.

Instead of averaging, the nearest neighbors may be approximated by a parabola, with the minimum of the parabola being used for position determination. This method is very robust with respect to tolerances.

This variant is advantageous for example if the method is to be carried out on a microcontroller that is seated on a circuit board on which the at least one Hall sensor is mounted. This means that the method is carried out in the angle detection system itself, rather than in a spatially separate control device that is connected to it and located remote from the angle detection system.

For example, the Hall sensor outputs to the control unit an individual signal corresponding to its structural shape with respect to the positions of the axes, and the control unit evaluates the measurement signals as a function of the structural shape. This allows Hall sensors of different structural shapes to be used without the accuracy of the determination of the angular position of the signal generator being impaired.

The control unit is, for example, configured to determine, on the basis of the measurement signals generated by the at least one Hall sensor, whether the signal generator rotates or moves axially. This is advantageous for example if a circuit board on which the at least one Hall sensor is arranged is used both in angle detection systems and in axial displacement measuring systems.

Furthermore, the control unit may be configured to determine whether an axially polarized magnet or a diametrically polarized magnet is present. This serves as an additional check as to whether a correct magnet has been used.

The object is furthermore achieved according to the disclosure by an angle detection system, in particular for carrying out a method as described above, including at least one at least biaxial Hall sensor and a magnetic signal generator which is mounted for rotation about an axis of rotation and includes a magnet that is polarized such that a magnetic field strength measured by the Hall sensor changes as the signal generator rotates, and which is arranged within the detection range of the at least one Hall sensor, wherein the Hall sensor is configured to generate at least two measurement signals in at least two different measuring directions on the basis of the magnetic field that changes due to rotation of the signal generator. As has already been described in connection with the method according to the disclosure, the measurement signals generated by the Hall sensor can be used to infer a current angular position of the signal generator. As a result, a rotation of the signal generator can be detected by means of the measuring system according to the disclosure.

The diametrically polarized magnet may be ring-shaped or cylinder-shaped and have at least two differently polarized segments. Also conceivable is a plurality of differently polarized segments that are arranged alternately in the circumferential direction. As an alternative, a bar magnet that can be pivoted about its transverse axis is also conceivable. A diametrically polarized magnet ensures that the magnetic field in the detection area of the Hall sensor changes upon a rotation of the signal generator, in contrast to an axially polarized magnet, the magnetic field of which would remain the same upon rotation.

In particular, the Hall sensor has a central axis which extends in the depth direction of the Hall sensor, wherein an axis of rotation of the signal generator is arranged concentrically, parallel or transversely, for example perpendicularly, to the central axis of the Hall sensor. In the arrangement transverse to the central axis of the Hall sensor, the Hall sensor may be arranged such that the extension of the central axis either intersects or extends past the signal generator. As a result, a flexible arrangement of the signal generator relative to the Hall sensor is possible, so that different installation space conditions can be flexibly responded to. The angle detection system is therefore versatile in its application.

The object is furthermore achieved according to the disclosure by a valve having an angle detection system as described above, wherein the valve comprises a positioning element for adjusting a flow cross-section through the valve, wherein the positioning element is coupled to the signal generator such that a position of the positioning element can be determined on the basis of an angular position of the signal generator. In a valve of this type, an opening state of the valve, for example a flow cross-section as adjusted, can therefore be determined by determining the angular position of the signal generator.

The valve has a rotating actuator, for example, with the signal generator being fastened to the actuator.

The positioning element may be a flap pivotably mounted by means of the actuator.

### BRIEF DESCRIPTION OF THE DRAWINGS

FIG. 1 schematically shows a valve according to the disclosure with an angle detection system according to the disclosure;

FIG. 2 shows a magnetic signal generator of the angle detection system according to the disclosure;

FIG. 3 shows a triaxial Hall sensor of the angle detection system according to the disclosure;

FIG. 4 shows a signal generator with a Hall sensor according to a first installation space arrangement;

FIG. 5 shows measurement signals of the Hall sensor in an arrangement relative to the signal generator according to FIG. 4;

FIG. 6 shows a signal generator with a Hall sensor according to a further installation space arrangement;

FIG. 7 shows measurement signals of the Hall sensor in an arrangement relative to the signal generator according to FIG. 6;

FIG. 8 schematically shows an angle detection system according to a further embodiment according to the disclosure;

FIG. 9 shows a signal generator and a Hall sensor of the angle detection system from FIG. 8;

FIG. 10 shows measurement signals of the Hall sensor in an arrangement relative to the signal generator according to FIGS. 8 and 9;

FIG. 11 schematically shows an angle detection system according to a further embodiment according to the disclosure;

FIG. 12 shows a signal generator and a Hall sensor of the angle detection system from FIG. 11;

FIG. 13 shows measurement signals of the Hall sensor in an arrangement relative to the signal generator according to FIGS. 11 and 12;

FIG. 14 shows steps for providing a set of position intensity data;

FIG. 15 shows further method steps; and

FIG. 16 shows steps of the method for angular position determination of the signal generator.

### DETAILED DESCRIPTION

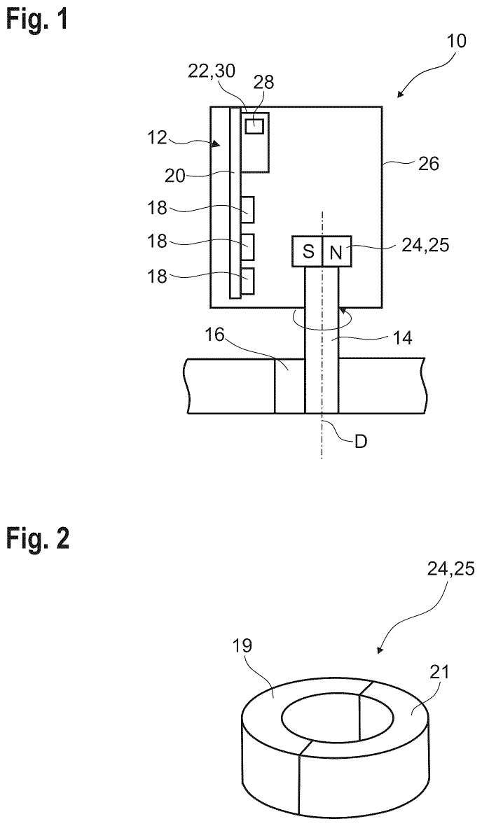

FIG. 1 schematically shows a valve 10 according to the disclosure with an angle detection system 12.

The valve 10 comprises a rotatably mounted valve tappet 14, which is connected to a positioning element 16 for adjusting a flow cross-section through the valve 10, for example a valve flap.

Rotation of the valve tappet 14 changes the position of the positioning element 16, resulting in an opening cross-section of the valve 10 being adjusted.

For rotating the valve tappet 14, a drive (electric, hydraulic, pneumatic) is provided, which however is not shown in the Figures for the sake of simplicity.

In the exemplary embodiment, the angle detection system 12 according to FIG. 1 comprises a plurality of, for example three, triaxial Hall sensors 18. In principle, however, a single Hall sensor 18 is sufficient.

As an alternative, the Hall sensors 18 may also be biaxial.

The Hall sensors 18 are arranged on a circuit board 20.

Moreover, a control unit 22 is provided, which is connected to the Hall sensors 18 in a signal-transmitting manner.

In the exemplary embodiment, the control unit 22 is in the form of a microcontroller 30. The latter is also arranged on the circuit board 20.

Furthermore, the angle detection system 12 comprises a magnetic signal generator 24 mounted for rotation about an axis of rotation D.

The signal generator 24 is arranged at one end of the valve tappet 14 and is therefore coupled to the positioning element 16 such that a position of the positioning element 16 can be determined on the basis of an angular position of the signal generator 24.

The signal generator 24 is arranged within the detection range of at least one of the Hall sensors 18.

Here, the signal generator 24 generates a magnetic field around its axis of rotation D.

The Hall sensors 18 are each configured to generate three measurement signals in three different measuring directions on the basis of the magnetic field that changes by rotation of the signal generator 24.

In the exemplary embodiment illustrated, the angle detection system 12 is accommodated in a control head 26 of the valve 10. It is, however, also conceivable that the control unit 22 is arranged outside the control head 26.

The signal generator 24 comprises a diametrically polarized magnet 25. A magnet of this type is illustrated by way of example in FIG. 2.

The magnet 25 illustrated in FIG. 2 is ring-shaped and has two differently polarized segments 19, 21.

However, other shapes of the magnet are also conceivable. For example, the magnet 25 may be cylindrical. In addition, it is conceivable that the magnet 25 has more than two differently polarized segments 19, 21.

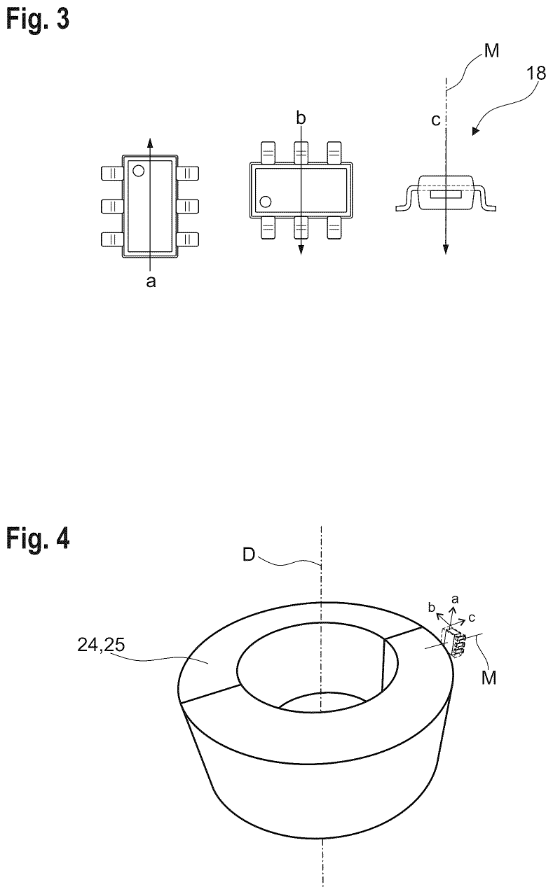

FIG. 3 shows an exemplary Hall sensor 18 in three different views. The Hall sensor 18 has a central axis M that extends in the depth direction of the Hall sensor 18.

Based on the magnetic field of the signal generator 24, the Hall sensor 18 generates signals in all spatial directions, including in the directions a, b and c. The directions a, b, c correspond to the axes of a coordinate system that is stored in the Hall sensor 18.

For example, direction a corresponds to the x-direction, direction b to the y-direction and direction c to the z-direction.

However, depending on the structural shape of the Hall sensor 18, the assignment within the Hall sensor 18 may also be different. The previously described assignment applies to the Infineon TLE493D sensor, for example. In the case of the Texas Instruments TMAG5173-Q1 sensor, the x-axis and the y-axis are interchanged in comparison to the Infineon sensor, so that the direction a corresponds to the y-direction and the direction b corresponds to the x-direction.

The Hall sensors 18 output to the control unit 22 an individual signal corresponding to their structural shape in relation to the positions of the axes.

The control unit 22 evaluates the measurement signals as a function of the structural shape.

More precisely, a position determination software 28 is stored in the control unit 22, as schematically illustrated in FIG. 1.

The position determination software 28 is configured to determine an angular position of the signal generator 24 based on the measurement signals generated by a Hall sensor 18. Furthermore, the position determination software 28 is configured to associate the measuring directions of the measurement signals generated by the Hall sensors with a respective axis of a coordinate system stored in the position determination software 28. In this way, a normalization of the measurement signals of the Hall sensor 18 is carried out, which allows Hall sensors 18 of different structural shapes to be employed.

During operation of the valve 10, when the signal generator 24 rotates about its axis of rotation D, at least one of the Hall sensors 18 generates three measurement signals Mₐ, M_{b}, M_{c} in the form of magnetic field components in the three different measuring directions a, b, c when the signal generator 24 rotates.

Based on the measurement signals generated by the at least one Hall sensor 18, an angular position of the signal generator 24 is determined in the control unit 22.

In order to determine the angular position of the signal generator 24, it is generally sufficient to have only one Hall sensor 18. However, it is conceivable to use the circuit board 20 as a common part in an axial displacement measuring system. In this case, a plurality of Hall sensors 18 can be arranged on the circuit board 20, as is illustrated in FIG. 1. For example, except for the signal generator 24, the same hardware and the same software can be used in an axial displacement measuring system as in the angle measuring system 12.

In this case, the control unit 22 is configured, for example, to determine with the aid of the measurement signals generated by the at least one Hall sensor 18 whether the signal generator 24 rotates or moves axially.

In addition, the control unit 22 can determine whether the magnet 25 is axially polarized or diametrically polarized.

The orientation of the signal generator 24 in relation to the at least one Hall sensor 18 may be different. Depending on the arrangement, the measurement signals of the at least one Hall sensor 18 may also differ. The arrangement of the Hall sensor 18 therefore has to be taken into account in the evaluation of the measurement signals.

FIG. 4 shows an arrangement in which an axis of rotation D of the signal generator 24 is arranged transversely to a central axis M of the Hall sensor 18, for example wherein the Hall sensor 18 is arranged such that the extension of the central axis M intersects the axis of rotation D of the signal generator 24.

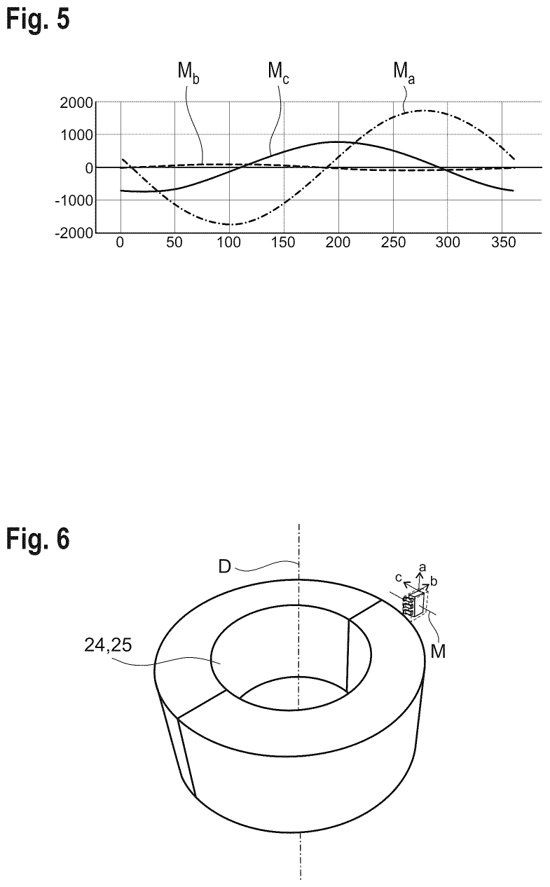

FIG. 5 illustrates the measurement signals Mₐ, M_{b}, M_{c} of the Hall sensor 18 of a corresponding setup when the signal generator 24 rotates.

In the case of a biaxial Hall sensor 18, the Hall sensor 18 only generates the measurement signals Mₐ, M_{c}.

FIG. 6 shows an alternative arrangement of the Hall sensor 18 in relation to the signal generator 24, in which the axis of rotation D of the signal generator 24 is also arranged transversely to the central axis M of the Hall sensor 18, but the central axis M extends past the signal generator 24. For example, the axis of rotation D is offset from the central axis of the signal generator 24.

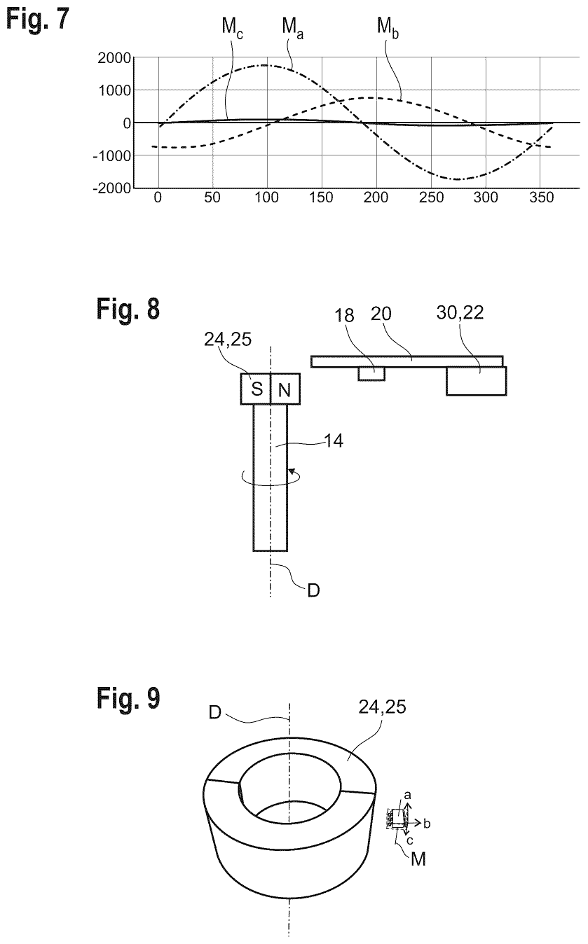

FIG. 7 illustrates the respective measurement signals Mₐ, M_{b}, M_{c} of the Hall sensor 18 of a setup according to FIG. 6 when the signal generator 24 rotates.

In the case of a biaxial Hall sensor 18, the Hall sensor 18 only generates the measurement signals Mₐ, M_{b}.

FIGS. 8 and 9 illustrate a further embodiment of the angle detection system 12, in which the axis of rotation D of the signal generator 24 is arranged parallel to the central axis of the Hall sensor 18.

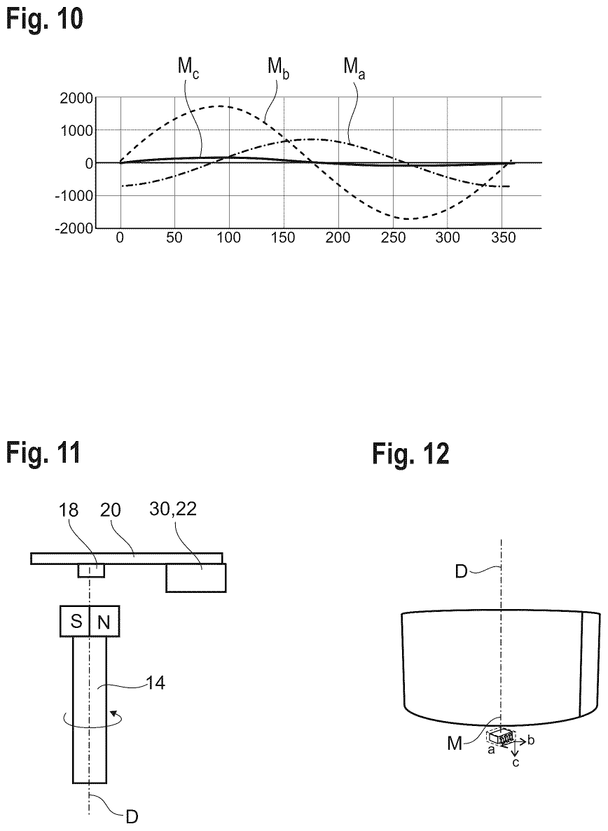

FIG. 10 illustrates the associated measurement signals Mₐ, M_{b}, M_{c}.

In the case of a biaxial Hall sensor 18, the Hall sensor 18 only generates the measurement signals Mₐ, M_{b}.

FIGS. 11 and 12 show a further embodiment of the angle detection system 12, in which the axis of rotation D of the signal generator 24 is arranged concentrically with the central axis of the Hall sensor 18.

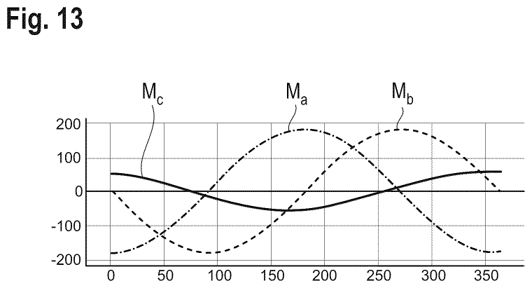

The associated measurement signals Mₐ, M_{b}, M_{c} are depicted in FIG. 13.

In the case of a biaxial Hall sensor 18, the Hall sensor 18 only generates the measurement signals Mₐ, M_{b}.

A method of determining an angular position p of the signal generator 24 and thus of the positioning element 16 by means of the angle detection system 12 will now be discussed in more detail below.

To this end, in one method step, at least one set of position intensity data Bₐ, B_{b}, B_{c} of the at least one Hall sensor 18 is provided for a multitude of specified angular positions pᵢ of the signal generator 24. The position intensity data Bₐ, B_{b}, B_{c} are stored in the position determination software 28.

As already discussed above, only a single Hall sensor 18 is needed for the case of application of an angle detection system 12, although the method is also applicable in the event that a plurality of Hall sensors 18 is used.

The position intensity data Bₐ, B_{b}, B_{c} can be calculated or be determined by rotating the signal generator 24 through a predetermined angular range, for example through 360 degrees, and recording the measurement signals generated as well as the associated angular position p.

A combination of both methods is also possible. For example, the basic characteristic curves for a rotation of the signal generator 24 may be determined for one type of angle detection system 12, while other parameters such as ambient temperature and aging phenomena are calculated into the characteristic curves using analytical or empirically determined correction factors.

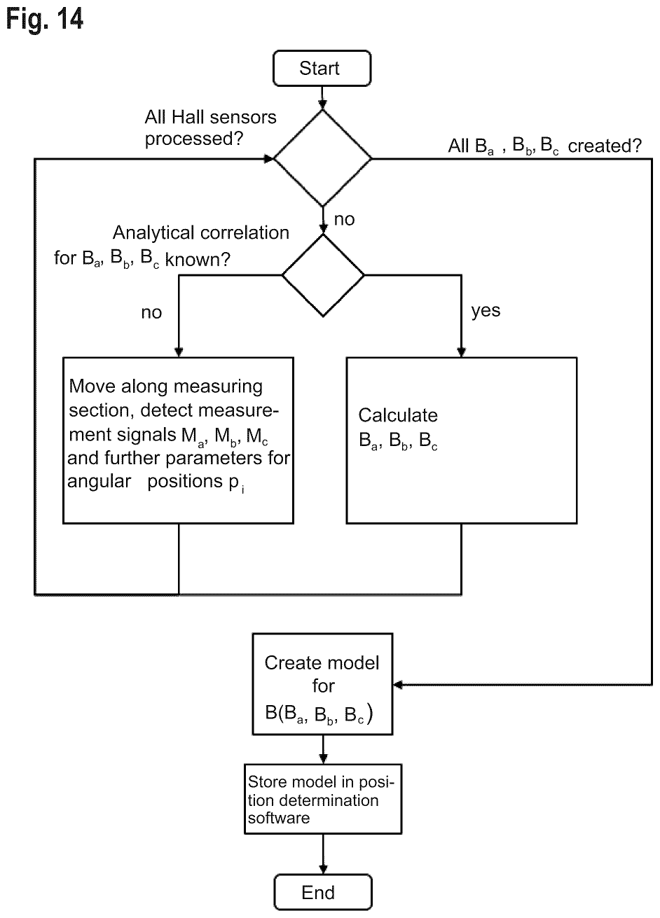

The creation of the position intensity data Bₐ, B_{b}, B_{c} is illustrated in FIG. 14.

The position intensity data Bₐ, B_{b}, B_{c} establish a relationship between specified angular positions pᵢ in an entire measurement range and measurement signals Mₐ, M_{b}, M_{c} generated by the Hall sensor 18.

The position intensity data Bₐ, B_{b}, B_{c} comprise, for example, characteristic curves of the Hall sensor 18 for different parameters, for example different ambient temperatures or aging times of the Hall sensor 18 and the signal generator 22.

The set of position intensity data Bₐ, B_{b}, B_{c} can be created outside the angle detection system 12 and transmitted to the control unit 22 of the angle detection system 12 and stored there. It is, however, also conceivable that the position intensity data Bₐ, B_{b}, B_{c} are generated within the angle detection system 12 itself.

For example, the position intensity data Bₐ, B_{b}, B_{c} are stored in the form of a matrix which contains a value for each of the specified angular positions pᵢ, for each Hall sensor 18, for each measuring direction a, b, c and, where applicable, for further parameters.

For example, a multitude of matrices may also be stored, each of which was created for specific values of the individual parameters.

In order to determine a current angular position p of a signal generator 24 during operation of the valve, a respective current measurement signal Mₐ, M_{b}, M_{c} is generated by the Hall sensor 18 for each measuring direction for a current angular position of the signal generator 24.

In a further method step, a current angular position p of the signal generator 24 is determined from the position intensity data Bₐ, B_{b}, B_{c} and the current measurement signals Mₐ, M_{b}, M_{c}.

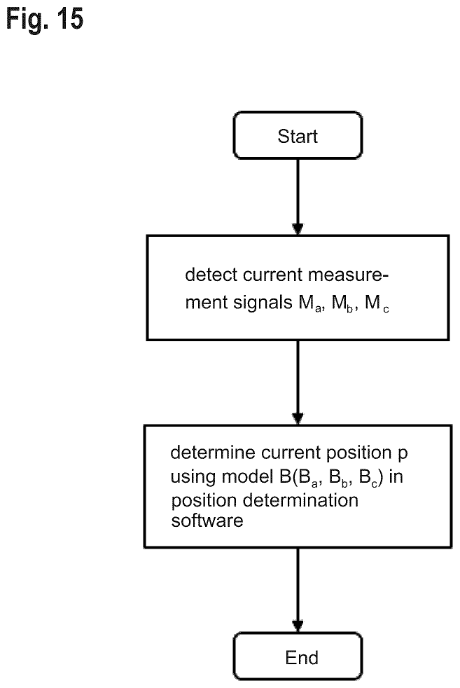

This process is illustrated in FIG. 15.

The method is carried out for example on the microcontroller 30, which is located on the circuit board 20, on which the at least one Hall sensor 18 is also arranged.

The current measurement signals Mₐ, M_{b}, M_{c} for a current angular position p of the signal generator 24 can be combined to form a measurement vector \vec{M(p)}.

The position p is determined from the position intensity data Bₐ, B_{b}, B_{c} for the current measurement signals Mₐ, M_{b}, M_{c}.

This is performed exclusively using the position intensity data Bₐ, B_{b}, B_{c} and the current measurement signals Mₐ, M_{b}, M_{c} without further computing operations with the current measurement signals Mₐ, M_{b}, M_{c}, for example by a suitable comparison of the current measurement signals Mₐ, M_{b}, M_{c} with the position intensity data Bₐ, B_{b}, B_{c}.

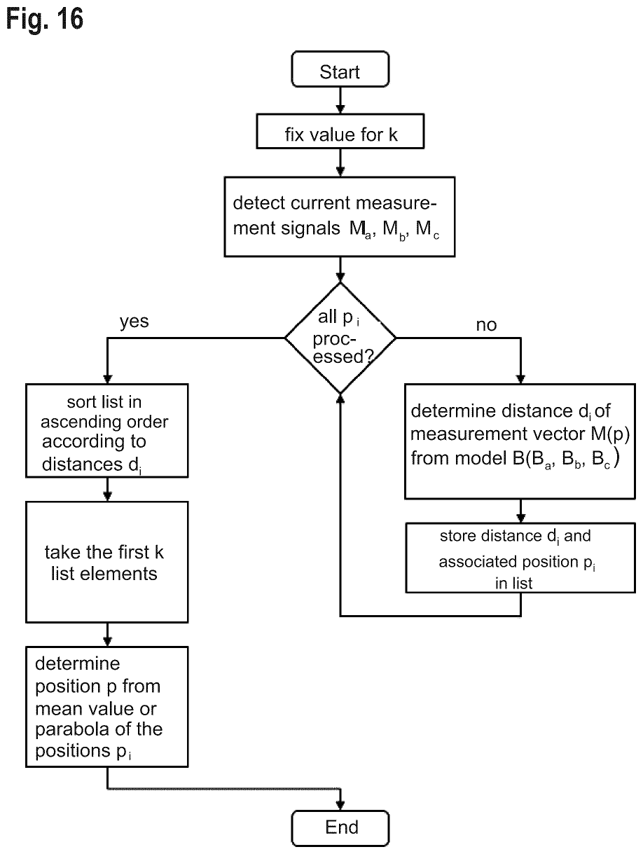

To determine the position p, a nearest neighbors classification or regression is made use of, for example, as is outlined in FIG. 16.

In this method, a distance dᵢ of the respective current measurement signal Mₐ, M_{b}, M_{c} from the characteristic curves of the set of position intensity data Bₐ, B_{b}, B_{c} applicable to the recorded or selected parameters is determined for each specified position pᵢ.

The distances dᵢ and the respectively associated position pᵢ are saved in a list. This list is sorted in ascending order according to the size of the distances dᵢ.

The position pᵢ with the smallest distance dᵢ can be assumed to be the current position p, or a weighting, for example an averaging, can be performed, for example over the positions pᵢ to the k smallest distances dᵢ, which is then assumed to be the current position p. Here, for example, a choice of k=1 has proven to be suitable if a very large number of positions pᵢ are provided, k=3 if the measurement data used for determining the position intensity data Bₐ, B_{b}, B_{c} is noisy or weak, and k=2 in most other cases.

This algorithm is optionally further optimized, e.g. by reducing the range of the data to be considered. For example, a decision tree based on simple comparisons is used here, which utilizes the characteristic shape of the characteristic curves. The middle of the range to be examined may, for example, be defined using a threshold value of one or two measurement signals Mₐ, M_{b}, M_{c}. The number of levels or branches the decision tree should have here depends on the specific circumstances of the application.

A further optimization is the reduction of the position intensity data Bₐ, B_{b}, B_{c} by a downsampling method. The measurement resolution reduced as a result is compensated for by weighting, for example averaging, for example over the positions pᵢ with the distances dᵢ (weighted kNN). This means that the accuracy of the predicted position is improved by averaging over the predicted most probable positions weighted with their probabilities.

This is advantageous for example if the method is to be carried out on the microcontroller 30, in particular on a microcontroller having limited storage space, which is already integrated e.g. in the angle detection system, i.e. a microcontroller that does not have the performance of an external control device. This microcontroller is preferably located on the same circuit board on which the Hall sensor(s) is/are also located.

Alternatively, an angular position of the signal generator 24 may be effected by an approximation of the measurement signals Mₐ, M_{b}, M_{c} to a parabola. In this method, some nearest neighbors are determined, for example four nearest neighbors, and subsequently a parabola is created on which the nearest neighbors are situated. The minimum of the parabola serves as a position prediction.

The comparison of the current measurement signals Mₐ, M_{b}, M_{c} with the position intensity data Bₐ, B_{b}, B_{c} may, of course, be carried out in any suitable way. For example, instead of the nearest neighbors classification or regression described above, a random forest classification or regression could also be used.

1. A method of determining an angular position of a magnetic signal generator mounted for rotation about an axis of rotation, for example of determining an opening state of a valve, in an angle detection system which comprises a signal generator and at least one at least biaxial Hall sensor which is configured to generate at least two measurement signals in at least two different measuring directions on a basis of a magnetic field that changes due to rotation of the signal generator, the signal generator comprising a magnet that is polarized such that a magnetic field strength measured by the Hall sensor changes as the signal generator rotates, and the signal generator being arranged within the detection range of the at least one Hall sensor, comprising the following steps:
rotating the signal generator about its axis of rotation;
when the signal generator rotates, the at least one Hall sensor generates at least two measurement signals in the form of magnetic field components in the at least two different measuring directions; and
based on the measurement signals generated by the at least one Hall sensor, determining an angular position of the signal generator in a control unit.

2. The method according to claim 1, wherein, based on the measurement signals generated by the at least one Hall sensor, the angular position of the signal generator is determined in the control unit on the principle of machine learning.

3. The method according to claim 1, wherein the control unit is connected to the at least one Hall sensor in a signal-transmitting manner, wherein the control unit has a position determination software stored therein which is configured to determine an angular position of the signal generator based on the measurement signals generated by the at least one Hall sensor, and wherein the position determination software is configured to associate the measuring directions of the measurement signals generated by the Hall sensors with a respective axis of a coordinate system stored in the position determination software.

4. The method according to claim 3, wherein in one method step, a set of position intensity data of the at least one Hall sensor is provided for a multitude of specified angular positions of the signal generator, wherein in a further method step, a respective current measurement signal for each measuring direction is generated by the Hall sensor for a current angular position of the signal generator, and wherein at in yet a further method step, a current angular position of the signal generator is determined from the position intensity data and the current measurement signals.

5. The method according to claim 4, wherein, to provide the position intensity data, the signal generator is rotated through a predetermined angular range, in particular through 360 degrees, and the measurement signals generated and also the associated angular position are recorded.

6. The method according to claim 4, wherein the position intensity data is calculated.

7. The method according to claim 4, wherein the set of position intensity data is created outside the angle detection system and transmitted to the control unit of the angle detection system and stored there.

8. The method according to claim 4, wherein a current angular position of the signal generator is performed using machine learning or deep learning.

9. The method according to claim 8, wherein a current angular position of the signal generator is performed using machine learning or deep learning in accordance with a nearest neighbors classification or regression or a random forest classification or regression.

10. The method according to claim 4, wherein the amount of position intensity data obtained is reduced by a downsampling method and the accuracy of the predicted position is improved by a weighting.

11. The method according to claim 1, wherein the method is carried out on a microcontroller which is seated on a circuit board on which the at least one Hall sensor is also arranged.

12. The method according to claim 1, wherein the Hall sensor outputs to the control unit an individual signal corresponding to its structural shape with respect to the positions of the axes, and the control unit evaluates the measurement signals as a function of the structural shape.

13. The method according to claim 1, wherein the control unit is configured to determine, on the basis of the measurement signals generated by the at least one Hall sensor, whether the signal generator rotates or moves axially.

14. The method according to claim 1, wherein the control unit is configured to determine whether an axially polarized magnet or a diametrically polarized magnet is present.

15. An angle detection system, comprising at least one at least biaxial Hall sensor and a magnetic signal generator which is mounted for rotation about an axis of rotation and includes a magnet that is polarized such that a magnetic field strength measured by the Hall sensor changes as the signal generator rotates, and which is arranged within the detection range of the at least one Hall sensor, wherein the Hall sensor is configured to generate at least two measurement signals in at least two different measuring directions on a basis of the magnetic field that changes due to rotation of the signal generator.

16. An angle detection system comprising at least one at least biaxial Hall sensor and a magnetic signal generator which is mounted for rotation about an axis of rotation and includes a magnet that is polarized such that a magnetic field strength measured by the Hall sensor changes as the signal generator rotates, and which is arranged within the detection range of the at least one Hall sensor, wherein the Hall sensor is configured to generate at least two measurement signals in at least two different measuring directions on a basis of the magnetic field that changes due to rotation of the signal generator, and which is configured to carry out a method according to claim 1.

17. The angle detection system according to claim 15, wherein the diametrically polarized magnet is ring-shaped or cylinder-shaped and has at least two differently polarized segments.

18. The angle detection system according to claim 15, wherein the Hall sensor has a central axis which is configured to extend in the depth direction of the Hall sensor, wherein an axis of rotation of the signal generator is arranged concentrically, parallel or transversely, to the central axis of the Hall sensor.

19. The angle detection system according to claim 15, wherein the Hall sensor has a central axis which is configured to extend in the depth direction of the Hall sensor, wherein an axis of rotation of the signal generator is arranged perpendicularly to the central axis of the Hall sensor.

20. A valve comprising an angle detection system according to claim 15, wherein the valve comprises a positioning element which is configured for adjusting a flow cross-section through the valve, wherein the positioning element is coupled to the signal generator such that a position of the positioning element can be determined on the basis of an angular position of the signal generator.
